(19) United States
(12) Patent Application Publication
(10) Pub. No.: US 2026/0370765 A1
(43) Pub. Date: Nov. 19, 2026

(54) READING APPARATUS AND IMAGE FORMING APPARATUS

(71) Applicant: KONICA MINOLTA, INC., Tokyo (JP)

(72) Inventor: Yoshito HASHIMURA, Kawasaki-shi (JP)

(73) Assignee: KONICA MINOLTA, INC., Tokyo (JP)

(21) Appl. No.: 19/670,876

(22) Filed: May 7, 2026

(30) Foreign Application Priority Data
May 14, 2025 (JP) 2025-081290

(51) Int. Cl. H04N 1/00; H04N 1/60

(52) U.S. Cl. CPC H04N 1/00602; H04N 1/00588; H04N 1/00591; H04N 1/00615; H04N 1/6044

(57) ABSTRACT

A reading apparatus includes: a first roller that conveys a recording medium on which an image has been formed; a second roller that receives the recording medium on which the image has been formed from the first roller; and a reader. When the second roller receives the recording medium on which the image has been formed from the first roller, the reader reads the recording medium positioned between the first roller and the second roller in a conveyance direction of the recording medium. The second roller is disposed such that at least part of the second roller is located upstream of a downstream end of the reader in the conveyance direction of the recording medium.

### CROSS-REFERENCE TO RELATED APPLICATIONS

The entire disclosure of Japanese Patent Application No. 2025-081290 filed on May 14, 2025, is incorporated herein by reference in its entirety.

### BACKGROUND OF THE INVENTION

### TECHNICAL FIELD

The present disclosure relates to a reading apparatus and an image forming apparatus.

### DESCRIPTION OF RELATED ART

An image forming apparatus forms a colorimetry image including multiple patches on a recording medium and performs colorimetry on the colorimetry image to adjust image color tones. Thus, image quality is maintained. Such a image forming apparatus includes a reader, such as a colorimeter, provided on a conveyance path through which the recording medium after image formation is conveyed. The recording medium is normally conveyed by an upstream roller disposed upstream of the reader and a downstream roller disposed downstream of the reader in the conveyance direction of the recording medium (see Japanese Unexamined Patent Application Publication No. 2023-43291). In the image forming system described in Japanese Unexamined Patent Application Publication No. 2023-43291, the downstream roller is disposed completely outside the reader (colorimeter) in the conveyance direction of the recording medium.

### SUMMARY OF THE INVENTION

When the downstream roller is disposed at a position separate from the reader in the conveyance direction of the recording medium, the recording medium may lift or sag relative to the reader. This causes a decrease in reading accuracy of the reader. In particular, when the reader includes a sensor that is movable in the width direction of the recording medium, the reader needs a moving mechanism for moving the sensor, which makes the reader large as a whole. Accordingly, with the reader that moves in the width direction of the recording medium, reading accuracy greatly decreases owing to floating or sagging of the recording medium.

The present disclosure has been made in view of the above-described problems in the known art. An object of the present disclosure is to improve reading accuracy of the reader.

To achieve at least one of the above-mentioned objects, according to an aspect of the present invention, a reading apparatus includes: a first roller that conveys a recording medium on which an image has been formed; a second roller that receives the recording medium on which the image has been formed from the first roller; and a reader, wherein: when the second roller receives the recording medium on which the image has been formed from the first roller, the reader reads the recording medium positioned between the first roller and the second roller in a conveyance direction of the recording medium, and the second roller is disposed such that at least part of the second roller is located upstream of a downstream end of the reader in the conveyance direction of the recording medium.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is an external view of an image forming apparatus according to a first embodiment;

FIG. 2 is a block diagram illustrating a functional configuration of the image forming apparatus;

FIG. 3 is a configuration diagram illustrating an example of a colorimetry device;

FIG. 4 is a diagram illustrating an example of a colorimetry chart on which a colorimetry image is formed;

FIG. 5 is a diagram for explaining the positional relationship between a colorimetry head and a downstream roller in a conveyance direction of a recording medium;

FIG. 6 is a diagram for explaining the positional relationship between the colorimetry head and the downstream roller in the conveyance direction of the recording medium;

FIG. 7 is a diagram for explaining the positional relationship between the colorimetry head and the downstream roller in the conveyance direction of the recording medium;

FIG. 8 is an enlarged schematic diagram of the colorimetry head, an upstream roller, and the downstream roller as viewed from the width direction of the recording medium;

FIG. 9 is a flowchart illustrating an overall process performed during colorimetry;

FIG. 10 is a flowchart illustrating a colorimetry process; and

FIG. 11 is a flowchart illustrating a second colorimetry process according to a second embodiment.

### DETAILED DESCRIPTION

Hereinafter, one or more embodiments of the present invention will be described with reference to the drawings. However, the scope of the invention is not limited to the disclosed embodiments. Advantages and features provided by the embodiments will be understood from the following detailed description and drawings. The dimensional ratios in each drawing are exaggerated for convenience of description and may differ from actual ratios.

### First Embodiment

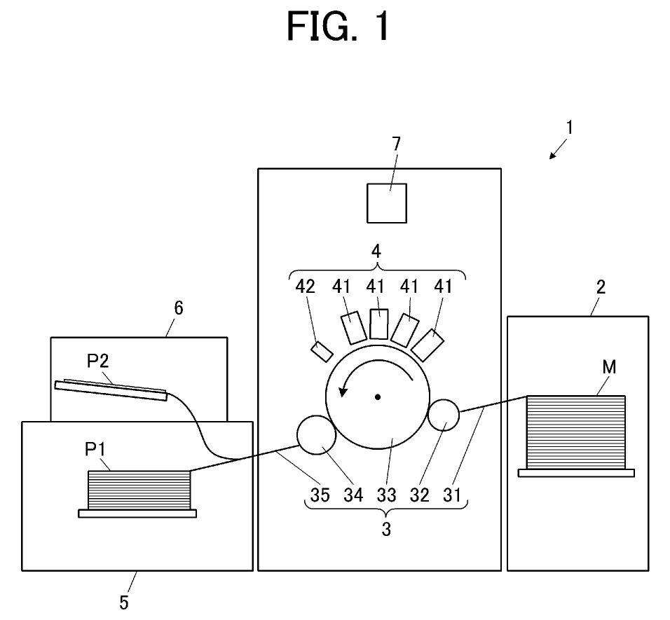

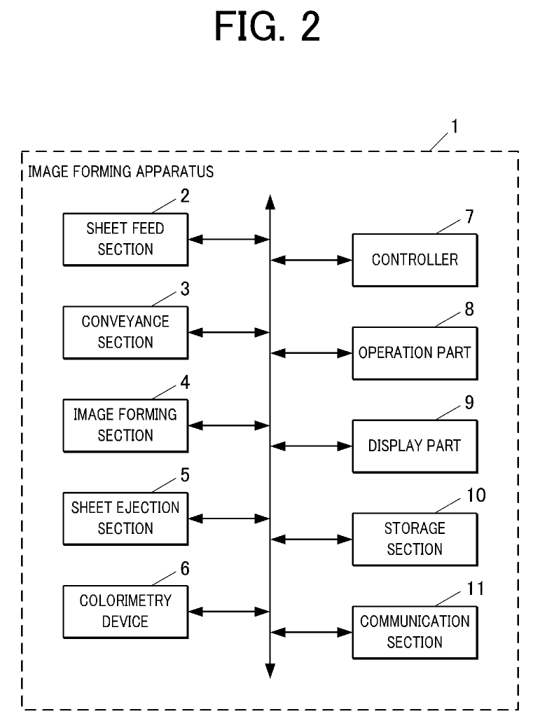

FIG. 1 is an external view of an image forming apparatus 1 (reading apparatus) according to a first embodiment. FIG. 2 is a block diagram illustrating a functional configuration of the image forming apparatus 1. The image forming apparatus 1 includes a sheet feed section 2, a conveyance section 3, an image forming section 4 (image former), a sheet ejection section 5, a colorimetry device 6, a controller 7 (hardware processor), an operation part 8, a display part 9, a storage section 10, and a communication section 11.

The sheet feed section 2 includes a sheet feed tray that stores the recording medium M and supplies the recording medium M to the image forming section 4. The recording medium M handled by the image forming apparatus 1 is, for example, a large-sized sheet. The large-sized sheets may be B2-size sheets (e.g., posters) and sheets to be cut into B2 size, for example. The recording medium M is not limited to paper. The recording medium M may be plain paper, embossed paper, synthetic media (coated paper and the like), translucent media, transparent plastic film, plastic card, aluminum vapor-deposited paper, colored high-quality paper, or textile, for example.

The conveyance section 3 conveys the recording medium M. As shown in FIG. 1, the conveyance section 3 includes a feeder board 31, a first delivery drum 32, a conveyance drum 33, a second delivery drum 34, and a carry-out section 35.

The feeder board 31 conveys the recording medium M from the sheet feed section 2 to the first delivery drum 32. The first delivery drum 32 holds and picks up one end of the recording medium M conveyed by the feeder board 31 and transfers the recording medium M to the conveyance drum 33.

The conveyance drum 33 is, for example, cylindrical. A circumferential side surface of the conveyance drum 33 serves as a conveyance surface that suction-adsorbs and holds the recording medium M. With the recording medium M held on the conveyance surface, the conveyance drum 33 rotates in one direction about a central axis. Accordingly, the conveyance drum 33 transports, along the conveyance surface, the recording medium M suction-attracted to and held on the conveyance surface.

The image forming section 4 includes one or more head units 41. The image forming section 4 forms an image on the recording medium M by an inkjet method to produce printed material. The head unit 41 has an ink ejection face at a position facing the conveyance surface of the conveyance drum 33. The head unit 41 discharges ink onto the recording medium M held on the conveyance drum 33 at an appropriate timing in accordance with the rotation of the conveyance drum 33, thereby forming an image and producing printed materials (a normal printed material P1, a colorimetry chart P2). The ink is not limited to a specific ink. For example, an ultraviolet-curable ink may be used.

In the image forming apparatus 1 illustrated in FIG. 1, the four head units 41 are arranged at predetermined intervals in order from an upstream side in a rotation direction of the conveyance drum 33. The four head units 41 correspond, respectively, to inks of four colors of yellow, magenta, cyan, and black, for example. The image forming section 4 includes an ultraviolet irradiation section 42 downstream of the head units 41 in the conveyance direction of the recording medium M. The ultraviolet irradiation section 42 cures the ink on the recording medium M by emitting ultraviolet light.

The image forming section 4 performs print jobs, such as normal jobs and a colorimetry job. A normal job is a print job for producing a normal printed material P1 that is not subject to colorimetry. A colorimetry job is a print job for producing a colorimetry chart P2 on which a colorimetry image has been formed.

The second delivery drum 34 holds and takes over one end of a printed material conveyed by the conveyance drum 33 and delivers the printed material to the carry-out section 35. The carry-out section 35 is a carry-out path for printed materials and conveys the printed materials to the sheet ejection section 5 or the colorimetry device 6. Specifically, the carry-out section 35 conveys a normal printed material P1 produced by the normal job to the sheet ejection section 5 and conveys a colorimetry chart P2 produced by the colorimetry job to the colorimetry device 6. The carry-out section 35 includes, for example, a belt and a roller. As shown in FIG. 1, the conveyance route in the carry-out section 35 may branch in the middle of the path. The sheet ejection section 5 includes, for example, a sheet ejection tray.

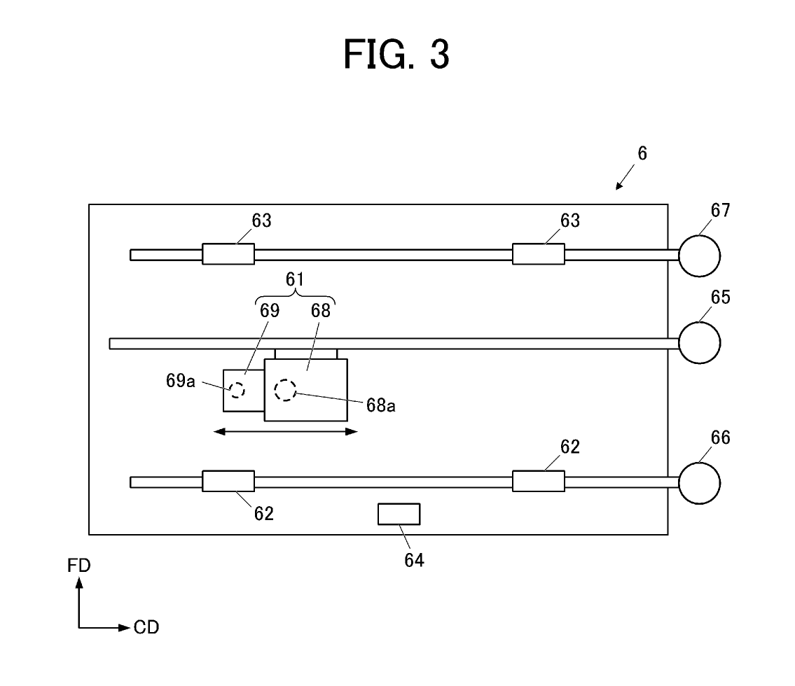

The colorimetry device 6 is an apparatus that performs colorimetry of (measures colors of) a colorimetry chart P2 and is disposed in-line in the image forming apparatus 1. That is, the colorimetry device 6 is provided at the conveyance route through which the colorimetry chart P2 (recording medium M) is conveyed. FIG. 3 is a block diagram illustrating an example of the colorimetry device 6. As shown in FIG. 3, the colorimetry device 6 includes a colorimetry head 61, upstream rollers 62, downstream rollers 63, a front end detection sensor 64, a first motor 65, a second motor 66, and a third motor 67.

The colorimetry head 61 (reader) includes a colorimetry sensor 68 and a position sensor 69.

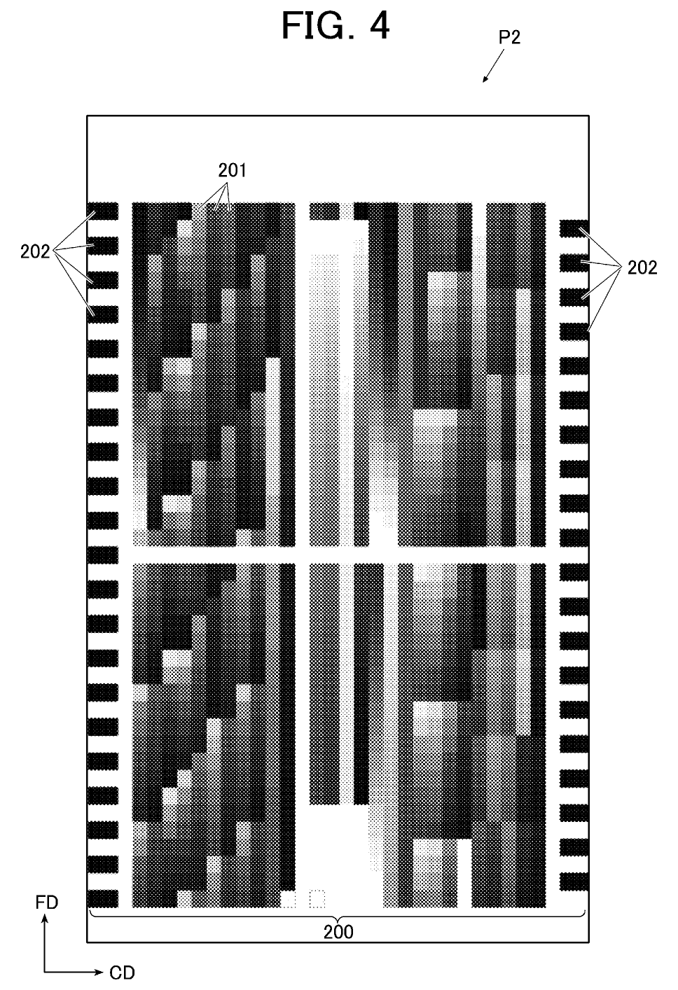

The colorimetry sensor 68 optically detects and measures the colors of colorimetry patches 201 (see FIG. 4). Colorimetry refers to obtaining color information and includes measuring color values, such as L*a*b values. As the colorimetry sensor 68, for example, a spectro-colorimeter may be used that spectrally separates reflected light from the colorimetry patch 201 to measure the color. The colorimetry sensor 68 has a reading region 68a on a surface that faces the colorimetry chart P2 and performs colorimetry on a colorimetry patch 201 corresponding to the reading region 68a. The colorimetry device 6 may be provided with a white calibration plate and may be calibrated by reading the white calibration plate with the colorimetry sensor 68 at a predetermined timing.

The position sensor 69 detects a position patch 202 (see FIG. 4). The position sensor 69 is, for example, mechanically attached adjacent to the colorimetry sensor 68 and is movable together with the colorimetry sensor 68. The position sensor 69 is preferably a single-wavelength reflective fiber-optic sensor or a reflective color sensor. For example, the position sensor 69 detects the position patch 202 based on a difference between the amount of received light in a white region and an amount of received light in a black region. The position sensor 69 has a reading region 69a on a surface facing the colorimetry chart P2 and detects a position patch 202 corresponding to the reading region 69a.

The upstream rollers 62 (first rollers) are conveyance rollers provided upstream of the reading region 68a of the colorimetry sensor 68 and the reading region 69a of the position sensor 69 in the conveyance direction of the recording medium M. The upstream rollers 62 convey the recording medium M on which an image has been formed.

The downstream rollers 63 (second rollers) are conveyance rollers provided downstream of the reading region 68a of the colorimetry sensor 68 and the reading region 69a of the position sensor 69 in the conveyance direction of the recording medium M. The downstream rollers 63 receive the recording medium M on which an image has been formed from the upstream rollers 62.

The upstream rollers 62 and the downstream rollers 63 convey the colorimetry chart P2 in a sub-scanning direction (feed direction (FD)) orthogonal to the main scanning direction.

The front end detection sensor 64 detects the front end of the recording medium M (colorimetry chart P2) being conveyed.

The first motor 65 causes the colorimetry head 61 to reciprocate in the main scanning direction (cross direction (CD)). That is, the colorimetry head 61 (reader) is movable in the width direction of the recording medium M by the first motor 65 (moving mechanism).

The second motor 66 is for rotating the upstream rollers 62.

The third motor 67 for rotating the downstream rollers 63.

The controller 7 controls operations of respective components constituting the image forming apparatus 1. The controller 7 causes the image forming apparatus 1 to form an image on the recording medium M based on image data, print settings, and the like. The controller 7 is a computer and includes, for example, a CPU (central processing unit), a RAM (random access memory), and a ROM (read-only memory). The CPU executes various control programs to drive and control the image forming apparatus 1 and performs various arithmetic operations. The RAM provides a working memory space for the CPU and stores temporary data. The ROM stores various control programs to be executed by the CPU, setting data, and the like. A rewritable non-volatile memory, such as a flash memory, may be used instead of the ROM. The controller 7 may be an external device including, for example, a personal computer (PC).

The controller 7 generates print data based on print jobs, such as a normal job and a colorimetry job. Specifically, the controller 7 performs raster image processing (RIP) on the image data to generate raster data. The controller 7 also performs image processing, such as color conversion and screening, on the image data. The print data is not necessarily generated by the controller 7, and may be pre-stored data. The controller 7 controls operations of the conveyance section 3, the image forming section 4, and the like to produce a printed material. Specifically, the controller 7 performs image processing, head unit drive control, ultraviolet irradiation control, transport control, colorimetry processing, and the like.

The operation part 8 includes a touch screen, a numeric keypad, a start button, and a stop button. The operation part 8 receives various user operations and outputs, to the controller 7, an operation signal based on the received operation. For example, the operation part 8 is used when a user inputs various print settings and information for creating an ICC profile.

The display part 9 includes a liquid crystal display (LCD) or the like and displays various screens in accordance with a display signal input from the controller 7.

The storage section 10 includes a hard disk drive (HDD), a solid-state drive (SSD), and non-volatile memory. The storage section 10 stores various data, such as parameters and files, required to execute various processes.

The communication section 11 includes a network interface. The communication section 11 transmits and receives data to and from an external device connected via a communication network.

FIG. 4 is a diagram illustrating an example of the colorimetry chart P2 on which the colorimetry image 200 is formed. The colorimetry image 200 includes a plurality of colorimetry patches 201 and a plurality of position patches 202.

The colorimetry patches 201 form columns arranged in the CD direction and rows arranged in the FD direction. Among the rows, the row on the most front-end side (upper side in FIG. 4) is a first row. The term "leading end side" refers to the leading end side in the conveyance direction of the colorimetry chart P2.

The position patches 202 are marks for the colorimetry device 6 to identify positions on the colorimetry image 200 (colorimetry patches 201) when the colorimetry image 200 is subjected to colorimetry. The position patches 202 indicate position information in the FD direction.

The position patches 202 are spaced apart from each other in the FD direction and are arranged on the left or right side or both sides of the colorimetry patches 201. Each position patch 202 is arranged such that its position in the FD direction coincides with the position of a corresponding row of the colorimetry patches 201. Specifically, the position patches 202 arranged in the FD direction on the left side of the colorimetry patches 201 are arranged such that their positions in the FD direction coincide with the positions of the odd-numbered rows of the colorimetry patches 201. The position patches 202 arranged in the FD direction on the right side of the colorimetry patches 201 are arranged such that their positions in the FD direction coincide with the positions of the even-numbered rows of the colorimetry patches 201. Here, the "left side" refers to the left side as viewed in the conveyance direction of the colorimetry chart P2. The "right side" refers to the right side as viewed in the conveyance direction of the colorimetry chart P2.

The controller 7 controls the image forming section 4 and the conveyance section 3 to form the colorimetry image 200 on the recording medium M, thereby producing the colorimetry chart P2.

The controller 7 causes the colorimetry device 6 to perform colorimetry of the colorimetry image 200 formed on the recording medium M.

When the downstream rollers 63 (second rollers) receive, from the upstream rollers 62 (first rollers), the recording medium M (colorimetry chart P2) on which an image has been formed, the controller 7 causes the colorimetry head 61 (reader) to read the recording medium M. The colorimetry head 61 reads the recording medium M on which an image has been formed at the position between the upstream rollers 62 and the downstream rollers 63 in the conveyance direction of the recording medium M. That is, in the conveyance direction of the recording medium M, the reading region 68a of the colorimetry sensor 68 and the reading region 69a of the position sensor 69 are located between the upstream rollers 62 and the downstream rollers 63.

The colorimetry head 61 (reader) includes a colorimetry sensor 68 (colorimeter) that measures the color of an image. When the downstream rollers 63 receive, from the upstream rollers 62, the recording medium M (colorimetry chart P2) on which an image has been formed, the colorimetry sensor 68 measures the color of the recording medium M.

The image formed on the recording medium M and read by the colorimetry head 61 is the colorimetry image 200 for colorimetry.

The colorimetry head 61 reads the colorimetry chart P2 when the downstream rollers 63 receive, from the upstream rollers 62, the recording medium M (colorimetry chart P2) on which the colorimetry image 200 has been formed.

The upstream rollers 62 convey the recording medium M (colorimetry chart P2) on which the image has been formed at a first speed.

The downstream rollers 63 convey the recording medium M (colorimetry chart P2) on which the image has been formed at a second speed. The second speed is faster than the first speed.

The downstream rollers 63 receive, from the upstream rollers 62, the recording medium M on which the image has been formed and convey the recording medium M on which the image has been formed by a predetermined distance. Thereafter, the controller 7 causes the colorimetry head 61 (colorimetry sensor 68) to read the recording medium M on which the image has been formed.

Here, the controller 7 determines the predetermined distance based on the paper type of the recording medium M on which the image has been formed. For example, when thin paper is used as the recording medium M, the controller 7 sets the predetermined distance to be longer than when plain paper or thick paper is used. Classifications of paper types, such as thin paper, plain paper, and thick paper are determined beforehand based on the basis weight, sheet thickness, and the like of the recording medium M. The user may be allowed to change ranges of basis weight, sheet thickness, and the like of the recording medium M corresponding to the respective classifications such as thin paper, plain paper, and thick paper.

The upstream rollers 62 (first rollers) are first paired rollers. That is, the upstream rollers 62 include a pair of rollers. The upstream rollers 62 include a drive roller. The upstream rollers 62 include the drive roller to be rotationally driven and a driven roller that is driven to rotate in contact with the driving roller.

The downstream rollers 63 (second rollers) are second paired rollers. That is, the downstream rollers 63 include a pair of rollers. The downstream rollers 63 include a drive roller. The downstream rollers 63 include the drive roller to be rotationally driven and a driven roller that is driven to rotate in contact with the driving roller.

The controller 7 controls driving of the upstream rollers 62 and the downstream rollers 63.

In the conveyance direction of the recording medium M, the downstream rollers 63 (second rollers) are provided such that at least part of the downstream rollers 63 is located upstream of the downstream-side end of the colorimetry head 61 (reader). Here, the downstream-side end of the colorimetry head 61 is the most downstream end of the entire colorimetry head 61 in the conveyance direction of the recording medium M.

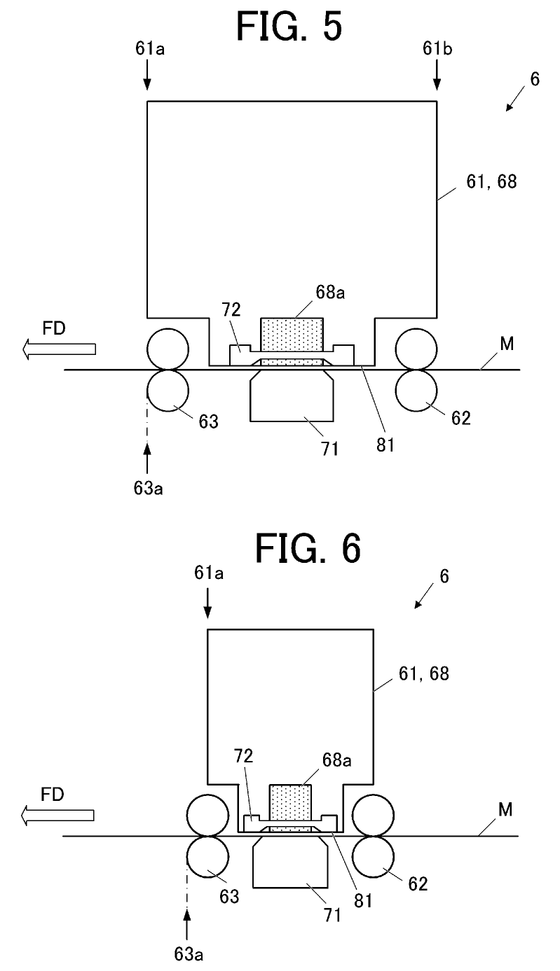

The positional relationship between the colorimetry head 61 and the downstream rollers 63 in the conveyance direction (FD direction) of the recording medium M will be described with reference to FIGS. 5-7. FIGS. 5-7 are schematic diagrams of the colorimetry device 6 when viewed in the width direction of the recording medium M. The colorimetry head 61 includes the colorimetry sensor 68 and the position sensor 69. In some cases, the colorimetry head 61 may be described with a focus on the colorimetry sensor 68 having a colorimetry function. In FIGS. 5-7, when viewed in the width direction of the recording medium M, it is assumed that the range of the colorimetry head 61 and the range of the colorimetry sensor 68 substantially coincide. The same applies to FIG. 8.

In FIG. 5, in the conveyance direction of the recording medium M, the entire downstream rollers 63 are provided upstream of the downstream-side end 61a of the colorimetry head 61. In FIG. 5, the downstream-side end 63a of the downstream rollers 63 substantially coincides with the downstream-side end 61a of the colorimetry head 61.

In the conveyance direction of the recording medium M, the entire upstream rollers 62 are disposed downstream of the upstream-side end 61b of the colorimetry head 61.

The length of the colorimetry head 61 in the conveyance direction of the recording medium M is shorter at the side closer to the conveyance path of the recording medium M. The downstream rollers 63 and the upstream rollers 62 are arranged so as to be inside the colorimetry head 61 in the conveyance direction of the recording medium M. In the conveyance direction of the recording medium M, the downstream rollers 63 and the upstream roller 62 are disposed on the downstream side and the upstream side of the colorimetry head 61, respectively, so as to be beneath the colorimetry head 61.

In FIG. 6, in the conveyance direction of the recording medium M, part of the downstream rollers 63 is disposed upstream of the downstream-side end 61a of the colorimetry head 61. In FIG. 6, the downstream-side end 63a of the downstream rollers 63 is located downstream of the downstream-side end 61a of the colorimetry head 61.

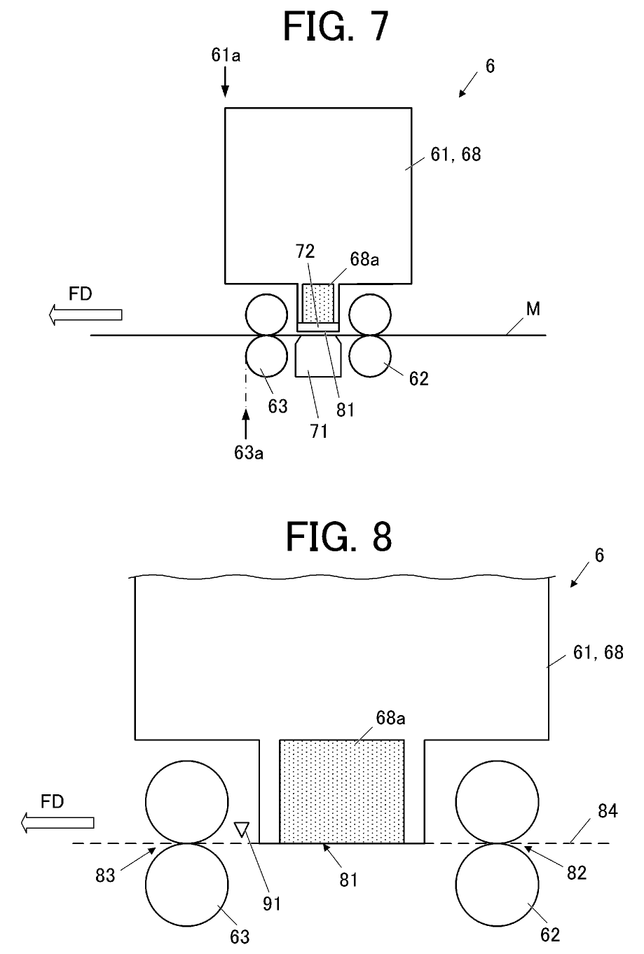

In FIG. 7, in the conveyance direction of the recording medium M, the entire downstream rollers 63 are disposed upstream of the downstream-side end 61a of the colorimetry head 61. In FIG. 7, the downstream-side end 63a of the downstream rollers 63 is located upstream of the downstream-side end 61a of the colorimetry head 61.

The positional relationship between the colorimetry head 61 and the downstream rollers 63 in the conveyance direction of the recording medium M is not limited to the illustrated examples.

As shown in FIGS. 5-7, a lower guide plate 71 (guide plate) that guides conveyance of the recording medium M is provided at a position facing the reading surface 81 of the colorimetry head 61 (in particular, the colorimetry sensor 68). The reading surface 81 of the colorimetry head 61 faces the recording medium M located between the upstream rollers 62 and the downstream rollers 63. The lower guide plate 71 presses the recording medium M in a direction perpendicular to the reading surface 81 of the colorimetry head 61. In FIGS. 5-7, the lower guide plate 71 presses the recording medium M upward. For example, the lower guide plate 71 pushes the recording medium M upward by means of an elastic member, such as a spring.

The direction in which the recording medium M is pressed is not limited to the direction perpendicular to the reading surface 81 of the colorimetry head 61 in a strict sense. Here, "perpendicular" includes a case in which the recording medium M is pressed substantially perpendicular to the reading surface 81 of the colorimetry head 61. The direction in which the lower guide plate 71 presses the recording medium M may deviate, within a predetermined range, from a direction perpendicular to the reading surface 81 of the colorimetry head 61.

The lower guide plate 71 may be provided over the width direction of the recording medium M. For another example, the lower guide plate 71 may have a partial width in the width direction of the recording medium M, and may be configured to be movable in the width direction of the recording medium M with movement of the colorimetry head 61.

The colorimetry head 61 includes an upper guide plate 72 (a second guide plate) configured to guide conveyance of the recording medium M at a position facing the lower guide plate 71. The upper guide plate 72 is integrally formed with the colorimetry head 61 (colorimetry sensor 68).

The upper guide plate 72 may be provided over the entire width of the colorimetry head 61 in the width direction of the recording medium M. Alternatively, in the width direction of the recording medium M, the upper guide plate 72 may be provided only over the extent of the colorimetry sensor 68.

The lower guide plate 71 and the upper guide plate 72 need only guide conveyance of the recording medium M. The shapes of the lower guide plate 71 and the upper guide plate 72 are not limited to a specific shape.

No member for preventing lifting of the recording medium M is provided between the colorimetry head 61 and the downstream rollers 63.

FIG. 8 is an enlarged schematic diagram of the colorimetry head 61, the upstream rollers 62, and the downstream rollers 63 as viewed in the width direction of the recording medium M. In FIG. 8, the lower guide plate 71 and the upper guide plate 72 are not shown. FIG. 8 shows a slack detector 91, which will be described in a second embodiment.

The reading surface 81 of the colorimetry head 61 (reader), the contact surface 82 of the upstream rollers 62 (first paired rollers), and the contact surface 83 of the downstream rollers 63 (second paired rollers) are on an identical plane 84.

At the contact surface 82 of the upstream rollers 62, the paired rollers constituting the upstream rollers 62 are in contact with each other.

At the contact surface 83 of the downstream rollers 63, the paired rollers constituting the downstream rollers 63 are in contact with each other.

Note that the identical plane 84 need not be an identical same plane in a strict sense. The “identical plane" includes a state in which the reading surface 81 of the colorimetry head 61, the contact surface 82 of the upstream rollers 62, and the contact surface 83 of the downstream rollers 63 substantially coincide with one another, and these surfaces may be displaced relative to one another within a predetermined range. Ideally, it is desirable that a distance between the reading surface 81 of the colorimetry head 61 and the recording medium M (colorimetry chart P2) during colorimetry be zero.

Next, the operation of the image forming apparatus 1 according to the first embodiment will be described.

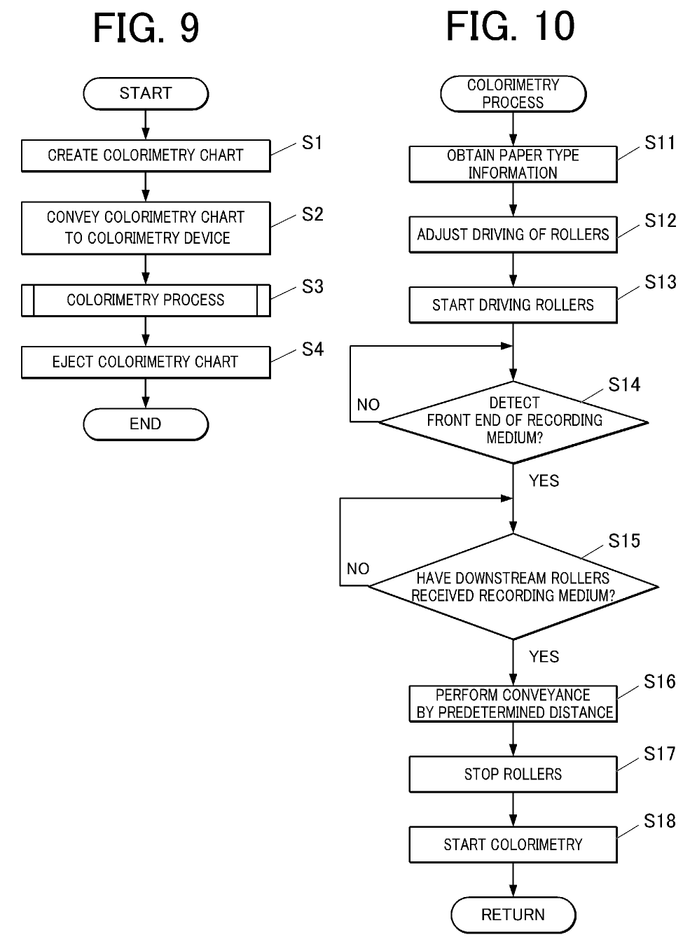

FIG. 9 is a flowchart illustrating an overall process performed during colorimetry. This process is performed by the CPU of the controller 7 in cooperation with a program stored in the ROM.

First, the controller 7 generates a colorimetry chart P2 (step S1). The controller 7 controls the conveyance section 3 and the image forming section 4 to form a colorimetry image 200 on the recording medium M based on image data for creating the colorimetry chart, thereby generating the colorimetry chart P2.

Next, the controller 7 controls the conveyance section 3 to convey the colorimetry chart P2 to the colorimetry device 6 (step S2).

Next, the controller 7 performs the colorimetry process on the colorimetry chart P2 (step S3).

Next, the controller 7 ejects the colorimetry chart P2 (step S4).

Thus, the overall process at colorimetry is completed.

FIG. 10 is a flowchart illustrating details of the colorimetry process in step S3.

First, the controller 7 acquires paper type information of the recording medium M (the colorimetry chart P2) on which the colorimetry image 200 has been formed (step S11). For example, the controller 7 acquires paper type information stored in the storage section 10 as the paper type information of the recording medium M on which the colorimetry chart P2 is to be created. Alternatively, a sensor that detects characteristics of the recording medium M may be provided in the conveyance route or the sheet feed tray of the sheet feed section 2, and the controller 7 may acquire paper type information of the recording medium M based on the output by the sensor.

Next, the controller 7 adjusts driving of the upstream rollers 62 and the downstream rollers 63 based on the acquired paper type information (step S12). For example, the controller 7 adjusts the second motor 66 such that the recording medium M is conveyed by the upstream rollers 62 at a first speed. The controller 7 adjusts the third motor 67 such that the recording medium M is conveyed by the downstream rollers 63 at a second speed. The second speed is greater than the first speed.

Next, the controller 7 controls the second motor 66 and the third motor 67 to start driving the upstream rollers 62 and the downstream rollers 63 (step S13). By driving the upstream rollers 62 and the downstream rollers 63, the colorimetry chart P2 is conveyed through the colorimetry device 6.

Next, the controller 7 determines whether the front end detection sensor 64 has detected the front end of the recording medium M (colorimetry chart P2) being conveyed (step S14). When the front end detection sensor 64 detects the front end of the recording medium M (step S14; YES), the process proceeds to step S15. In step S15, the controller 7 determines whether the downstream rollers 63 have received the recording medium M (colorimetry chart P2) from the upstream rollers 62. Specifically, the controller 7 calculates the conveyance distance after the front end detection sensor 64 detects the front end of the recording medium M, and determines whether the downstream rollers 63 have received the recording medium M based on the conveyance distance.

When the downstream rollers 63 receive the recording medium M from the upstream rollers 62 (step S15; YES), the process proceeds to step S16. In step S16, the controller 7 controls the second motor 66 and the third motor 67 to cause the upstream rollers 62 and the downstream rollers 63 to convey the recording medium M by a predetermined distance. The controller 7 sets the predetermined distance used in step S16 based on the paper type information acquired in step S11.

Next, the controller 7 controls the second motor 66 and the third motor 67 to stop the upstream rollers 62 and the downstream rollers 63 (step S17).

Next, the controller 7 controls the colorimetry head 61 to start colorimetry of the recording medium M (colorimetry chart P2) (step S18).

The controller 7 determines the position of the colorimetry patches 201 based on the position patches 202 detected by the position sensor 69. The controller 7 drives the first motor 65 to move the colorimetry head 61 (colorimetry sensor 68) in the CD direction. The controller 7 controls the colorimetry sensor 68 to measure each colorimetry patch 201. When the colorimetry target row is an odd-numbered row, the controller 7 moves the colorimetry head 61 from left to right. When the colorimetry target row is an even-numbered row, the controller 7 moves the colorimetry head 61 from right to left. The controller 7 causes the storage section 10 to store information for identifying the colorimetry patch 201 subjected to colorimetry and a color value (e.g., L*a*b* values) obtained from the colorimetry patch 201 in association from each other.

Each time colorimetry of the colorimetry patches 201 in the target row is completed, the controller 7 drives the second motor 66 and the third motor 67 to cause the upstream rollers 62 and the downstream rollers 63 to convey the colorimetry chart P2 in the FD direction. In this manner, the controller 7 causes the colorimetry sensor 68 to measure all the colorimetry patches 201.

Thus, the colorimetry process is completed.

The controller 7 uses colorimetry data of the respective colorimetry patches 201 obtained in the colorimetry process for color management (e.g., color adjustment, color verification) of the image forming apparatus 1. For example, the controller 7 may perform color calibration or generate an ICC profile.

Further, the controller 7 may transmit, via the communication section 11, colorimetry data obtained in the colorimetry process to an external device. Color management of the image forming apparatus 1 may be performed by the external device.

In the colorimetry process, the controller 7 may omit step S16.

As described above, in the image forming apparatus 1 according to the first embodiment, when the downstream rollers 63 receive, from the upstream rollers 62, the recording medium M (colorimetry chart P2) on which an image has been formed, the colorimetry head 61 (reader) reads the recording medium M on which the image has been formed. That is, reading by the colorimetry head 61 is started after the leading end of the recording medium M is nipped by the nip portion of the downstream rollers 63. This can prevent the recording medium M from floating and sagging during reading by the colorimetry head 61, thereby enabling stable reading.

Further, the downstream rollers 63 are provided such that at least part of the downstream rollers 63 is located upstream of the downstream end of the colorimetry head 61 in the conveyance direction of the recording medium M. By shortening the distance between the downstream rollers 63 and the reading region of the colorimetry head 61 (the reading region 68a of the colorimetry sensor 68), it is possible to prevent floating and sagging of the recording medium M and to improve reading accuracy of the colorimetry head 61 (reader). Since the downstream rollers 63 extend to the inside of the colorimetry head 61, the downstream rollers 63 can nip the recording medium M earlier, the colorimetry head 61 start reading earlier. Even when the colorimetry image 200 is formed near the leading end of the recording medium M, colorimetry can be performed on the colorimetry image 200. The greater the area on which the colorimetry image 200 can be formed on the recording medium M is, the greater the size of the colorimetry patches 201 can be in the colorimetry chart P2. Accordingly, stable reading can be performed without designing the apparatus with high precision, and a cost increase can be suppressed.

The colorimetry head 61 (reader) is movable by the first motor 65 (moving mechanism) in the width direction of the recording medium M. Such a colorimetry head 61 may increase the overall unit size. On the other hand, according to the first embodiment, the distance between the downstream rollers 63 and the reading region of the colorimetry head 61 is shortened. This can prevent floating and sagging of the recording medium M and improve reading accuracy of the colorimetry head 61.

In addition, when the downstream rollers 63 receive, from the upstream rollers 62, the recording medium M on which an image has been formed, the colorimetry sensor 68 (colorimeter) performs colorimetry on the recording medium M on which the image has been formed. Accordingly, it is possible to improve the colorimetry accuracy of the colorimetry sensor 68.

Further, the conveyance speed (second speed) of the recording medium M by the downstream rollers 63 is greater than the conveyance speed (first speed) of the recording medium M by the upstream rollers 62. Accordingly, in the conveyance direction of the recording medium M, the recording medium M is pulled downstream and can be avoided from sagging.

Further, after the downstream rollers 63 receive the recording medium M on which an image has been formed from the upstream rollers 62 and convey the recording medium M by a predetermined distance, the colorimetry head 61 (colorimetry sensor 68) reads the recording medium M on which the image has been formed. Accordingly, the colorimetry head 61 can read the recording medium M more stably.

Further, the controller 7 sets the predetermined distance based on the paper type of the recording medium M on which an image has been formed. Thus, the colorimetry head 61 can perform stable reading according to the paper type.

The reading surface 81 of the colorimetry head 61 (reader), the contact surface 82 of the upstream rollers 62 (first paired rollers), and the contact surface 83 of the downstream rollers 63 (second paired rollers) are on the identical plane 84. By reducing the distance between the reading surface 81 of the colorimetry head 61 and the recording medium M during colorimetry to near zero, it is possible to improve the reading accuracy of the colorimetry head 61.

The lower guide plate 71 presses the recording medium M in a direction perpendicular to the reading surface 81 of the colorimetry head 61. Accordingly, it is possible to prevent the recording medium M from lifting and to improve reading accuracy of the colorimetry head 61.

Further, since the upper guide plate 72 is provided on the colorimetry head 61 side, conveyance of the recording medium M is further stabilized, and reading accuracy of the colorimetry head 61 can be improved.

### Second Embodiment

Next, a second embodiment will be described.

The image forming apparatus according to the second embodiment has the same configuration as the image forming apparatus 1 according to the first embodiment. Therefore, components that are the same as those of the first embodiment are denoted by the same reference numerals, and a description thereof is omitted. Hereinafter, characteristic aspects of the configuration and the process in the second embodiment will be described.

When the downstream rollers 63 (second roller) receive, from the upstream rollers 62 (first roller), the recording medium M (colorimetry chart P2) on which an image has been formed, the controller 7 of the image forming apparatus 1 causes the colorimetry head 61 (reader) to read the recording medium M on which the image has been formed.

Before causing the colorimetry head 61 to read the recording medium M on which an image has been formed, the controller 7 stops the upstream rollers 62 before stopping the downstream rollers 63.

As shown in FIG. 8, the image forming apparatus 1 includes a slack detector 91 (detector). The slack detector 91 detects slack in the recording medium M between the upstream rollers 62 and the downstream rollers 63. The slack detector 91 includes, for example, an imaging unit configured to capture an image of the recording medium M to acquire image data, and detects slack in the recording medium M based on the image data.

Before causing the colorimetry head 61 to read the recording medium M on which an image has been formed, the controller 7 stops the downstream rollers 63 and then rotates the upstream rollers 62 in a reverse direction.

Here, after the downstream rollers 63 are stopped, the controller 7 may rotate the upstream rollers 62 in a reverse direction when the slack detector 91 detects slack at a predetermined level or greater.

Next, the operation of the image forming apparatus 1 according to the second embodiment will be described. The overall process shown in FIG. 9 is substantially the same as that of the first embodiment. Differences from the first embodiment will be described below.

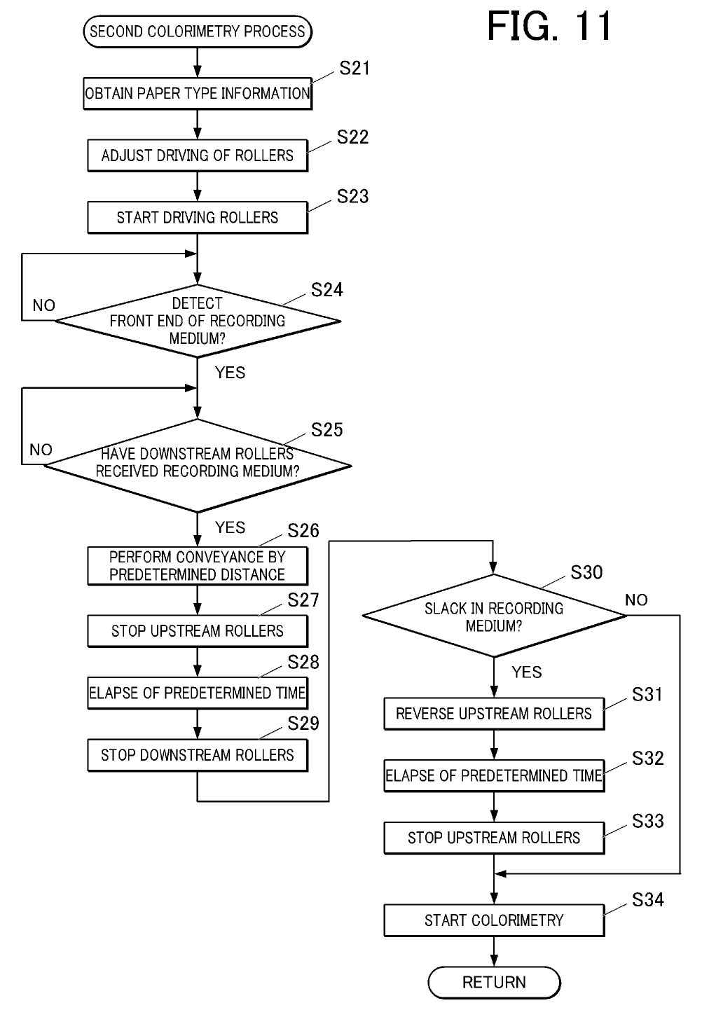

In the second embodiment, a second colorimetry process shown in FIG. 11 is performed instead of the colorimetry process of step S3 in FIG. 10.

Since steps S21 to S26 are the same as steps S11 to S16 in the colorimetry process, description thereof will be omitted.

After step S26, the controller 7 controls the second motor 66 to stop the upstream rollers 62 (step S27).

Next, the controller 7 waits until a predetermined time elapses after the upstream rollers 62 are stopped (step S28).

Next, the controller 7 controls the third motor 67 to stop the downstream rollers 63 (step S29).

Next, the controller 7 determines whether the recording medium M (the colorimetry chart P2) between the upstream rollers 62 and the downstream rollers 63 has slack at or above a predetermined level (step S30). Specifically, the controller 7 determines whether the recording medium M has slack at or above a predetermined level, based on a detection result acquired from the slack detector 91.

When the recording medium M has slack at or above a predetermined level (step S30: YES), the controller 7 controls the second motor 66 to rotate the upstream rollers 62 reversely (step S31).

Next, the controller 7 waits until a predetermined time elapses after the upstream rollers 62 have been reversely rotated (step S32).

Next, the controller 7 controls the second motor 66 to stop the upstream rollers 62 (step S33).

After step S33, or in step S30, when the recording medium M does not have slack at or above a predetermined level (step S30: NO), the process proceeds to step S34. In step S34, the controller 7 controls the colorimetry head 61 to start colorimetry of the recording medium M (colorimetry chart P2). Details of the colorimetry operation are the same as those of the first embodiment.

Thus, the second colorimetry process is completed.

In the second colorimetry process, the controller 7 may not perform determination in step S30. Specifically, the controller 7 performs the processing of steps S31 to S34 on the recording medium M between the upstream roller 62 and the downstream roller 63, regardless of whether slack is present.

Further, in the second colorimetry process, instead of steps S31 to S33, the controller 7 may control the third motor 67 to drive the downstream rollers 63 for a predetermined time so as to feed the recording medium M downstream. By conveying the recording medium M by the downstream rollers 63 while the upstream rollers 62 are stopped, the same effect as that obtained by steps S31 to S33 can be obtained.

In the second colorimetry process, the controller 7 may omit step S26.

As described above, according to the second embodiment, as in the first embodiment, the reading accuracy of the colorimetry head 61 (reader) can be improved.

Further, the controller 7 stops the upstream rollers 62 before stopping the downstream rollers 63 (steps S27 to S29). Thus, between the upstream rollers 62 and the downstream rollers 63, the recording medium M is pulled downstream. This eliminates slack in the recording medium M.

After stopping the downstream rollers 63, the controller 7 rotates the upstream rollers 62 in reverse (steps S29 and S31). As a result, between the upstream rollers 62 and the downstream rollers 63, the recording medium M is pulled toward the upstream side. This eliminates slack in the recording medium M.

Further, after stopping the downstream rollers 63, the controller 7 may rotate the upstream rollers 62 in reverse only when the slack detector 91 detects slack at or above a predetermined level (step S29, S30: YES, S31). In this case, the controller 7 can remove slack on the recording medium M as needed.

The description in each of the above embodiments is merely an example of a reading apparatus and an image forming apparatus, and the present disclosure is not limited thereto. The detailed configuration and operation of each unit constituting the apparatus may also be modified as appropriate without departing from the spirit of the present disclosure.

In each of the above-described embodiments, the reader that reads the recording medium M is a colorimeter (colorimetry head 61 and colorimetry sensor 68) configured to perform colorimetry on an image. Alternatively, the reader configured to read the recording medium M may be an inspection unit configured to inspect an abnormality in an image. The inspection unit may acquire color information of the recording medium M as an inspection target or may capture an image of the inspection target recording medium M to acquire image data. For example, based on color information acquired from the recording medium M, the inspection unit inspects whether the colors of an image formed on the recording medium M are correctly reproduced as compared with target values. The inspection unit compares image data acquired from the recording medium M with reference data, and inspects whether there are scratches, dust, or the like on the recording medium M. As the reference data, print data (original data) or image data (scan data) obtained from defect-free printed material may be used. When the downstream rollers 63 receive, from the upstream rollers 62, the recording medium M on which an image has been formed, the controller 7 causes the inspection unit to inspect the recording medium M on which the image has been formed. The inspection unit outputs the inspection result to the controller 7. Since the downstream rollers 63 are provided such that at least part of the downstream rollers 63 is located upstream of the downstream end portion of the colorimetry head 61 in the conveyance direction of the recording medium M, the inspection accuracy of the inspection unit can be improved.

In the above-described embodiments, the downstream rollers 63 are positioned such that at least part of the downstream rollers 63 is located inside and below the colorimetry head 61. For another example, in comparison with the above embodiments, the positional relationship between the downstream rollers 63 and the colorimetry head 61 may be reversed in the vertical direction across the conveyance route of the recording medium M.

Further, the surface of the recording medium M passing through the colorimetry head 61 may not be horizontal. For example, the surface of the recording medium M passing through the colorimetry head 61 may be inclined relative to a horizontal plane. When the recording medium M is viewed from the colorimetry head 61 side in the direction perpendicular to the surface of the recording medium M, at least part of the downstream rollers 63 should be positioned so as to be hidden by the colorimetry head 61 in the conveyance direction of the recording medium M.

It is preferable to adjust the position of the colorimetry patches 201 from the front end of the colorimetry chart P2 so that colorimetry can be started immediately when the downstream rollers 63 receive the recording medium M (colorimetry chart P2) from the upstream rollers 62. Further, when colorimetry is performed after the downstream rollers 63 receive the recording medium M and convey the recording medium M by a predetermined distance, it is preferable to adjust the position of the colorimetry patches 201 from the front end of the colorimetry chart P2 so that colorimetry can be started immediately after the conveyance.

Examples of a computer-readable medium storing a program for executing each process are not limited to the above examples. Further, a carrier wave (carrier) may be used as a medium for providing program data via a communication line.

Although embodiments of the present invention have been described and illustrated in detail, the disclosed embodiments are provided for purposes of illustration and example only and not for limitation. The scope of the present invention should be construed in accordance with the terms of the appended claims.

What is claimed is:

1. A reading apparatus comprising:
a first roller that conveys a recording medium on which an image has been formed;
a second roller that receives the recording medium on which the image has been formed from the first roller; and
a reader, wherein:
when the second roller receives the recording medium on which the image has been formed from the first roller, the reader reads the recording medium positioned between the first roller and the second roller in a conveyance direction of the recording medium, and
the second roller is disposed such that at least part of the second roller is located upstream of a downstream end of the reader in the conveyance direction of the recording medium.

2. The reading apparatus according to claim 1, wherein the reader is movable in a width direction of the recording medium by a moving mechanism.

3. The reading apparatus according to claim 1, wherein:
the reader is a colorimeter that performs colorimetry of the image, and
when the second roller receives the recording medium on which the image has been formed from the first roller, the colorimeter performs colorimetry of the recording medium on which the image has been formed.

4. The reading apparatus according to claim 3, wherein the image is a colorimetry image to be used for colorimetry.

5. The reading apparatus according to claim 1, wherein:
the reader is an inspector that inspects the image for an abnormality, and
when the second roller receives the recording medium on which the image has been formed from the first roller, the inspector inspects the recording medium on which the image has been formed.

6. The reading apparatus according to claim 1, wherein:
the first roller conveys the recording medium on which the image has been formed at a first speed, and
the second roller conveys the recording medium on which the image has been formed at a second speed greater than the first speed.

7. The reading apparatus according to claim 1, wherein the reader reads the recording medium on which the image has been formed after the second roller receives the recording medium from the first roller and conveys the recording medium by a predetermined distance.

8. The reading apparatus according to claim 7, wherein the predetermined distance is set based on a paper type of the recording medium on which the image has been formed.

9. The reading apparatus according to claim 1, wherein:
the first roller includes first paired rollers,
the second roller includes second paired rollers, and
a reading surface of the reader, a contact surface between the first paired rollers, and a contact surface between the second paired rollers pair are on an identical plane.

10. The reading apparatus according to claim 1, further comprising a guide plate at a position facing a reading surface of the reader, the guide plate guiding the recording medium being conveyed,
wherein the guide plate presses the recording medium in a direction perpendicular to the reading surface of the reader.

11. The reading apparatus according to claim 10, further comprising a second guide plate at a position facing the reading surface of the reader, the second guide plate guiding the recording medium being conveyed.

12. The reading apparatus according to claim 1, wherein:
the first roller and the second roller include a drive roller,
the reading apparatus further comprises a hardware processor that controls driving of the first roller and the second roller, and
and the hardware processor stops the first roller before stopping the second roller.

13. The reading apparatus according to claim 1, wherein:
the first roller and the second roller include a drive roller,
the reading apparatus further comprises a hardware processor that controls driving of the first roller and the second roller, and
the hardware processor reverses the first roller after stopping the second roller.

14. The reading apparatus according to claim 13, further comprising a detector that detects slack in the recording medium between the first roller and the second roller,
wherein the hardware processor reverses the first roller when the detector detects slack at or above a predetermined level after the second roller is stopped.

15. An image forming apparatus comprising:
an image former that forms an image on a recording medium;
a first roller that conveys the recording medium on which the image has been formed;
a second roller that receives the recording medium on which the image has been formed from the first roller; and
a reader, wherein:
when the second roller receives the recording medium on which the image has been formed from the first roller, the reader reads the recording medium positioned between the first roller and the second roller in a conveyance direction of the recording medium, and
the second roller is disposed such that at least part of the second roller is located upstream of a downstream end of the reader in the conveyance direction of the recording medium.
